(19) United States
(12) Patent Application Publication
(10) Pub. No.: US 2013/0052309 A1
(43) Pub. Date: Feb. 28, 2013

(54) OXYGEN EMITTERS IN PACKAGED MEAT PRODUCTS

(71) Applicant: Timothy A. Stubbs, Glenview, IL (US)

(72) Inventor: Timothy A. Stubbs, Glenview, IL (US)

(73) Assignee: Sara Lee Corporation

(21) Appl. No.: 13/593,405

(22) Filed: Aug. 23, 2012

Related U.S. Application Data
(60) Provisional application No. 61/526,973, filed on Aug. 24, 2011.

(51) Int. Cl. B65D 81/24; B65B 31/00; A23B 4/00; B65D 81/20

(52) U.S. Cl. 426/124; 206/213.1; 53/432; 426/129

(57) ABSTRACT

A packaging for food products includes a food package forming an interior configured to receive a food product and an oxygen emitter configured to emit oxygen into the interior.

### CROSS-REFERENCE TO RELATED PATENT APPLICATIONS

This application claims the benefit of U.S. Provisional Application No. 61/526,973, filed Aug. 24, 2011, which is incorporated by reference herein in its entirety.

### BACKGROUND

The present disclosure relates generally to the field of packaged food products, and more specifically, to packaged food products for meats and similar food products having food packaging including oxygen emitters.

### SUMMARY

One embodiment relates to a packaging for food products comprising a food package forming an interior configured to receive a food product; and an oxygen emitter configured to emit oxygen into the interior.

Another embodiment relates to a method for packaging a food product, the method comprising providing a food packaging configured to receive a food product; positioning a food product comprising a meat food product within an interior of the food packaging; and disposing an oxygen emitter within the interior configured to emit oxygen into the interior.

Another embodiment relates to a packaged food product comprising a packaging having an interior; a meat food product disposed within the interior; and an oxygen emitter configured to emit oxygen to the interior of the packaging.

### BRIEF DESCRIPTION OF THE DRAWINGS

FIG. 1 is a perspective view of a packaged food product according to an exemplary embodiment.

FIG. 2 is a cross section view of the packaged food product of FIG. 1 according to an exemplary embodiment.

FIG. 3 is an exploded perspective view of the packaged food product of FIG. 1 according to an exemplary embodiment.

FIG. 4 is a perspective view of an oxygen emitter according to an exemplary embodiment.

FIG. 5 is a side view of a portion of the packaged food product of FIG. 1 according to an exemplary embodiment.

FIG. 6 is a side view of a portion of the packaged food product of FIG. 1 according to another exemplary embodiment.

### DETAILED DESCRIPTION OF EXEMPLARY EMBODIMENTS

There are multiple modified atmosphere packaging (MAP) approaches to preserving packaged food products, one of which is high-Oxygen packaging which typically requires excess head space and relatively expensive packagings. Various embodiments disclosed herein may provide advantages over current high-oxygen packagings, including reducing/eliminating excess headspace, reducing overall packaging size, and reducing associated costs with food packaging.

Packaged food products such as packaged meats typically have a limited shelf life. In other words, the amount of time a packaged food product may be provided for sale to consumers is limited due to the eventual spoilage of the food over time. Additionally, food products such as meats may become less visually appealing over time due to changes in appearance (e.g., a change in color of meat, etc.), even though the food product is otherwise still saleable and safe for consumption. The deterioration in the visual appearance of food products may further limit the shelf life of certain foods, as consumers may be unlikely to purchase visually unappealing products.

One factor contributing to changes in the appearance of food products such as meats is the presence/absence of oxygen gas (O₂). Many packages are initially packaged with a certain amount of oxygen (e.g., 80% O₂ mixed with 20% CO₂). The CO₂ assists in delaying spoilage of the meat and maintaining the shelf life of the food product. The meat within the packages initially has a desirable reddish color when exposed to oxygen. The formation of the reddish color or hue in surfaces of meats exposed to oxygen is sometimes referred to as “blooming.” As the oxygen within the packaging is depleted/consumed, the packaged meat may tend to change color (e.g., to a non-reddish color such as grey). Generally, blooming in meats results from myoglobin, a protein pigment found in meat, being exposed to oxygen. As meat “blooms” oxygen is consumed and/or escapes from the package. The period of “blooming” may be extended by providing a sufficient amount of oxygen within the package.

Various embodiments disclosed herein are directed to packagings for food products such as meats that may maintain a desired visual appearance of a food product. More specifically, various embodiments disclosed herein are directed to food packagings having oxygen emitters therein that are intended to maintain an appealing (e.g., reddish) color for packaged meats, while reducing/minimizing the required amount of head space in the packaging.

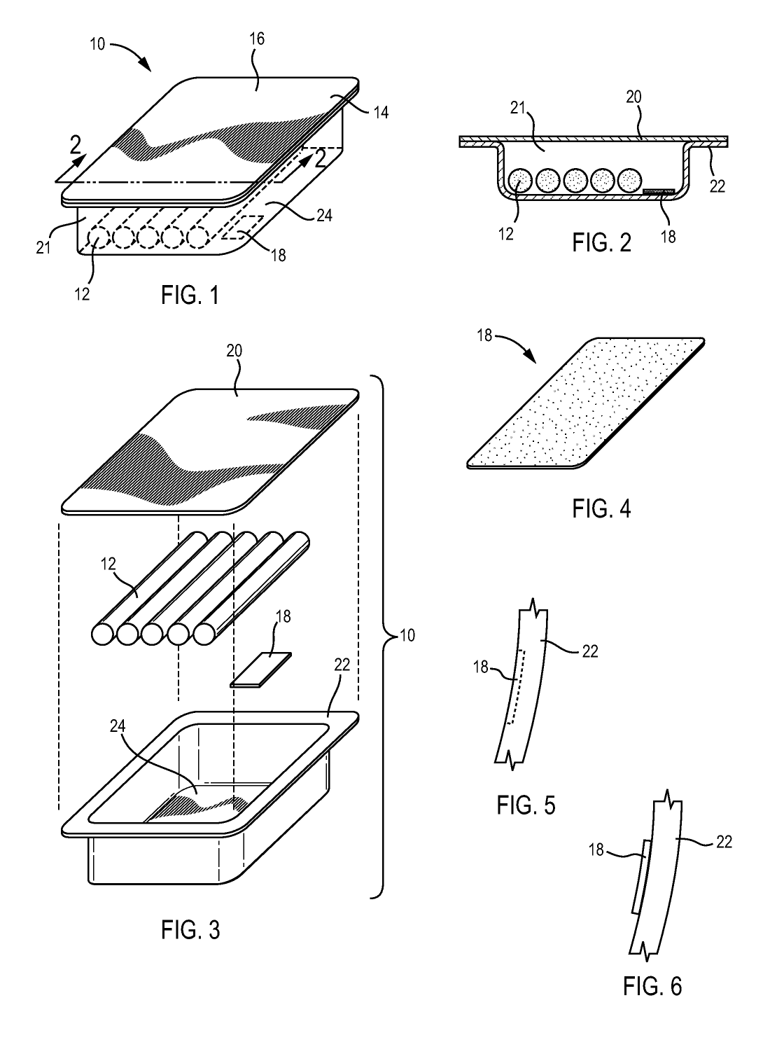

Referring now to FIG. 1, a packaged food product 10 is shown according to an exemplary embodiment, and includes a food product 12 and a food packaging 14. Food packaging 14 includes a package 16 and an oxygen emitter 18.

Packaged food product 10 may include a variety of food products and/or packaging shapes. For example, in one embodiment, food product 12 is a meat-based food product that may be provided in the form of links, as ground beef or poultry, etc., and package 16 may be or include a generally rectangular package that encloses the food product. According to various other embodiments, other types, shapes, and/or sizes of food products and packaging may be utilized.

According to an exemplary embodiment, food product 12 is a meat-based food product (e.g., sausage, sausage links, etc.) that normally has a desired color (e.g., a reddish color) when initially exposed to oxygen in the raw, or uncooked state. In some embodiments, food product 12 is intended to be sold in a refrigerated state, while in other embodiments, food product 12 may be frozen for a portion or all of the time during distribution or sale of the food product. Other food products which may be included in food packaging 14 include other types of sausage links, meat patties, whole meat portions, ground meat products such as ground beef or ground poultry, and the like.

According to an exemplary embodiment, food packaging 14 includes a package 16 and an oxygen emitter 18. In some embodiments, package 16 may be formed by one or more films 20, 22, such as a generally flat or planar upper film 20 and a formed lower film 22 that define an interior space 24. Interior space 24 is configured to receive food product 12 and or oxygen emitter 18. As shown in FIG. 1, a headspace 21 may be provided above and/or around food product 12. In some embodiments, increasing the amount of headspace within interior 24 increases the amount of oxygen available for consumption, in turn increasing the bloom time of the meat. As such, many conventional food products are provided with excessive volumes of headspace in order to maintain a sufficient level of oxygen within the packaging and maintain a desirable coloring of the food product. As discussed in greater detail below, use of an oxygen emitter within the packaging may enable reduction of the head space needed within the packaging (e.g., reducing a 0.75 inch headspace to a 0.125 inch headspace, etc.) and/or the spacing between food products.

According to an exemplary embodiment, oxygen emitter 18 is provided within interior 24 of package 16 and is intended to emit (produce, generate, release, etc.) oxygen to interior 24 of package 16. According to one embodiment, as shown in FIG. 3, oxygen emitter 18 may be a relatively thin packet (e.g., a satchel, package, etc.) configured to hold one or more materials (e.g., powders, etc.) selected to release/emit a desired amount of oxygen to interior 24. For example, in some embodiments, emitter 18 may include a satchel of approximately 0.5 in. wide, by approximately 1.25 inches long, by about 1-5 thousandths of an inch thick (or more), while according to various other embodiments other dimensions may be utilized (e.g., a thicker satchel, etc.). Further, in some embodiments, emitter 18 may include two sides of gas-permeable material (e.g., a paper-based material, etc.) which define an interior space, where one of the two sides of material is made of or includes a tear-resistant material such as a metalized film or the like.

According to some embodiments, emitter 18 may be integrated into package 16. For example, emitter 18 may be integrated into one or more portions of one or both of films 22, 24. In some embodiments, a channel may be formed in one or more portions of the film/package and emitter 18 may be integrated into the channel (e.g., in a powder-like form, etc.). Emitter 18 may be located in any suitable location and take any suitable size and/or shape. Furthermore, emitter may be provided between two layers of film.

According to some embodiments, emitter 18 is configured to emit oxygen at a desired rate (e.g., via a chemical reaction, gas trapped in a matrix, etc.). For example, the rate of oxygen emission by emitter 18 may be matched to the estimated rate of oxygen depletion within the package. Oxygen depletion may result from, for example, consumption of oxygen by the meat food product and escape of oxygen from the package. In other embodiments, emitter 18 may be configured to emit oxygen at a rate sufficient to maintain the amount of oxygen within the interior of the packaging at a desired level (e.g., 80%, etc.). As indicated above, the packaging may initially be gas-flushed to provide a ratio of 80% O₂ mixed with 20% CO₂, and emitter 18 may be configured to keep the level of oxygen within the package at about 80% (or another desired or suitable level). While in some embodiments a level of 80% oxygen may be used, in other embodiments, any level of oxygen above a naturally-occurring level may be utilized. According to various embodiments, the oxygen emitter provides a slow and regulated release of oxygen due a chemical reaction that may be triggered at least in part by moisture such that a high oxygen headspace is maintained, yet the emitter does not emit oxygen unless the oxygen level has been sufficiently depleted. In alternative embodiments, the oxygen emitter may be configured to release oxygen according to other parameters.

In some embodiments, where emitter 18 is integrated into the film/packaging and/or is provided in the space between two films, packaged food product 10 may be configured such that all or a portion of the surface of food product 12 may be in physical contact with all or a portion of the film/packaging to provide a better visual appearance. As shown in FIG. 5, emitter 18 may be coupled to a packaging sidewall, while as shown in FIG. 6, emitter 18 may be wholly or partly integrated into or provided within an interior of a packaging sidewall.

The oxygen emitter may take a wide variety of forms. In one embodiment, the oxygen emitter may be a polymer matrix within which O₂ is diffused, and which is configured to release the O₂ over a desired time period. Such polymers include, but are not limited to, polyolefins, polyethylene glycols (PEGs), silicone rubbers, natural rubbers, cellulose acetates, polysulfones, polycarbonates, polyesters, polysaccharides, polystyrenes, polyurethanes, polyamides, aramids, a co-polymer of any two or more such polymers, or a blend of any two or more such polymers. In some embodiments, the polymer may be a perfluorinated polymer or polymer comprising fluorinated alkyl groups.

In another embodiment, the oxygen emitter may be a perfluorocarbon compound that is sequestered within an oxygen permeable membrane. Illustrative perfluorocarbons include, but are not limited to, perfluorodecalin, tri(perfluoropropyl)amine, tri(perfluorononyl)amine, bromoperfluoro-n-octane, dicloroperfluoro-n-octane, or a mixture of any two or more thereof. In such embodiments, the compound maybe sequestered within an oxygen permeable polymer membrane formed into a package such as an envelope or satchel. Such polymers may include those as listed above. The perfluoro compound is exposed to O₂ gas prior to, or upon, sequestering within the oxygen permeable membrane to allow sufficient uptake of the O₂ within the compound. The release of the O₂ may be moderated by both the perfluorocarbon compound, the membrane, and the temperature of the overall package.

In another embodiment, the oxygen emitter may include a compound which degrades and/or reacts under specified conditions to generate oxygen, which is then released to the interior of the package with the food. The compound may be sequestered within a package made from an oxygen permeable membrane as described above. In one embodiment, the emitter comprises a carbonate (e.g., calcium carbonate, etc.) that reacts with moisture to release oxygen. Other compounds may include, but are not limited to, peroxides, superoxides, chlorates, or perchlorates. Specific compounds may include hydrogen peroxide, barium peroxide, lithium superoxide, sodium superoxide, potassium superoxide, sodium chlorate, potassium chlorate, or potassium perchlorate. Such compounds are known to degrade and generate oxygen, when the compounds are in the presence of UV light, other activators, or upon temperature variation. For example, upon exposure to UV light, hydrogen peroxide degrades to generate oxygen and hydrogen; or upon mixture of sodium chlorate with an activator such as iron, the sodium chlorate will degrade to generate oxygen. Such compounds may be sequestered within an oxygen permeable membrane to allow for diffusion of the oxygen out to the food product as the oxygen is generated and retain undesirable components, such as an activator, within the membrane so that it does not contact the food product.

In some embodiments, the packaging may further include a CO₂ emitter that releases or emits carbon dioxide to the interior of the packaging. CO₂ acts as an anti-microbial, with typical levels being at approximately 15% to be effective within the packaging, although more or less CO₂ may be used in alternative embodiments. Any suitable CO₂ emitter may be utilized, and the CO₂ emitter may be used within the packaging in combination with an O₂ emitter. In some embodiments, a combined O₂/CO₂ emitter may be utilized (e.g., such that both the CO₂ and O₂ emitters are provided within a common satchel, are embedded into the same packaging, etc.).

Providing a packaged food product such as that disclosed in the various embodiments herein may provide many benefits over conventional packaging. First, the bloom time and desirable coloring of meat food products may be maintained for longer periods of time, thereby potentially extending the shelf-life of food products. Furthermore, because less headspace may be required to provide the necessary oxygen, the size, and therefore cost, of the packaged food product (and similarly, the associated packaging such as pallets, boxes, etc.), may be reduced. Current packaging may utilize high oxygen contents with large headspaces that such that the food product is a considerable distance from the packaging and results in poor product visibility. Further yet, with an emitter that emits a sufficient amount of oxygen, initial gas flushing of packaging may be avoided, thereby further reducing packaging costs.

It is important to note that the construction and arrangement of the elements of the packaged food products and packagings as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the various embodiments. Accordingly, all such modifications are intended to be included within the scope of the present disclosure as defined in the appended claims. The order or sequence of any process or method steps may be varied or re-sequenced according to alternative embodiments. Other substitutions, modifications, changes, and/or omissions may be made in the design, operating conditions, and arrangement of the exemplary embodiments without departing from the spirit of the present disclosure.

What is claimed is:

1. A packaging for food products comprising:
a food package forming an interior configured to receive a food product; and
an oxygen emitter configured to emit oxygen into the interior.

2. The packaging of claim 1, wherein the oxygen emitter comprises a relatively flat second package provided within the interior of the food package.

3. The packaging of claim 1, wherein the oxygen emitter is integrated into the food package.

4. The packaging of claim 3, wherein the oxygen emitter is formed as part of a sidewall of the food package.

5. The packaging of claim 1, wherein the food package is gas-flushed to obtain a ratio of approximately 80 percent carbon dioxide to approximately 20 percent oxygen gas.

6. The packaging of claim 1, wherein the oxygen emitter is configured to emit oxygen to the interior at a predetermined rate.

7. The packaging of claim 6, wherein the oxygen emitter is configured to emit oxygen to maintain a desired approximate ratio of carbon dioxide to oxygen gas within the interior.

8. The packaging of claim 1, wherein the oxygen emitter comprises a carbonate compound configured to react with moisture to provide oxygen to the interior of the food package.

9. The packaging of claim 1, wherein the food product is configured to be maintained in a refrigerated state.

10. A method for packaging a food product, the method comprising:
providing a food packaging configured to receive a food product;
positioning a food product comprising a meat food product within an interior of the food packaging; and
disposing an oxygen emitter within the interior configured to emit oxygen into the interior.

11. The method of claim 10, wherein disposing the oxygen emitter within the interior comprises coupling the oxygen emitter to a sidewall of the packaging.

12. The method of claim 10, wherein the oxygen emitter is configured to emit oxygen to the interior at a predetermined rate.

13. The method of claim 10, wherein the oxygen emitter is configured to emit oxygen to maintain a desired approximate ratio of carbon dioxide to oxygen gas within the interior.

14. The method of claim 10, further comprising gas-flushing the packaging to obtain a ratio of approximately 80 percent carbon dioxide to approximately 20 percent oxygen gas.

15. A packaged food product comprising:
a packaging having an interior;
a meat food product disposed within the interior; and
an oxygen emitter configured to emit oxygen to the interior of the packaging.

16. The product of claim 15, wherein the oxygen emitter is configured to emit oxygen to the interior at a predetermined rate.

17. The product of claim 15, wherein the oxygen emitter is configured to emit oxygen to maintain a desired approximate ratio of carbon dioxide to oxygen gas within the interior.

18. The product of claim 15, wherein the packaging is gas-flushed to obtain a ratio of approximately 80 percent carbon dioxide to approximately 20 percent oxygen gas.

19. The product of claim 15, wherein the oxygen emitter is integrated into the packaging.

20. The product of claim 15, wherein the oxygen emitter is disposed within the interior as a separate component from the food package.
